(19) United States
(12) Patent Application Publication
(10) Pub. No.: US 2005/0178436 A1
(43) Pub. Date: Aug. 18, 2005

(54) Inflation valve

(76) Inventors: Detlev Ahlert, Ottery (ZA); Bester Jacobus Pansegrouw, Ottery (ZA); Howard Robert Stasin, Ottery (ZA)

Correspondence Address: STITES & HARBISON PLLC, 1199 NORTH FAIRFAX STREET, SUITE 900, ALEXANDRIA, VA, 22314, US

(21) Appl. No.: 10/778,342

(22) Filed: Feb. 17, 2004

(51) Int. Cl. F16K 15/20

(52) U.S. Cl. 137/223

(57) ABSTRACT

The invention discloses an inflation valve for inflating containers, which includes a housing including a first opening at a first end and a second opening at a second end, the housing being adapted to be secured to a container at the second end, and adapted to receive a gas filling nozzle at the first end; a disc adapted to close-off the second opening; and a resilient member associated with the housing and the disc, and being adapted in its inoperative position to hold the disc against the second, opening to close it off, and when gas is released by the filling nozzle into the housing to allow the disc to move away from the second opening against the action of the resilient member.

### FIELD OF INVENTION

The present invention relates to inflation valves.

More particularly, the invention relates to inflation valves for inflating containers with non-rigid-walls.

### BACKGROUND TO INVENTION

Various types of inflation valves exist for inflating containers with non-rigid walls, such as bags, sacks and dunnage bags. However, often the known inflation valves are difficult to operate or are expensive to manufacture.

It is an object of the invention to suggest a novel inflation valve.

### SUMMARY OF INVENTION

According to the invention, an inflation valve for inflating, containers, includes
(a) a housing including a first opening at a first end and a second opening at a second end, the housing being adapted to be secured to a container at the second end, and adapted to receive a gas filling nozzle at the first end;
(b) a disc adapted to close-off the second opening; and
(c) a resilient member associated with the housing and the disc, and being adapted in its inoperative position to hold the disc against the second opening to close it off, and when gas is released by the filling nozzle into the housing to allow the disc to move away from the second opening against the action of the resilient member.

The container may have non-rigid walls.

The first opening and the second opening may be perpendicular to each other.

The housing may be provided with a plate shaped part for securing the valve to the container.

The plate shaped part may be pivotally connected to the housing.

The housing may be provided with guiding members at the second end to guide the disc.

The disc may be provided with at least one washer.

The housing may be provided with a circumferential ridge around the second opening and against which the disc abuts for closing off the second opening.

The disc may be provided with a tubular part to receive the resilient member.

The tubular part may be adapted to protect the resilient member from the gas filling nozzle.

The resilient member may be an elongated rod slidingly arranged in a passage in the housing and having knobs at either end for preventing the rod from being withdrawn from the passage.

The housing may be provided with guiding means for guiding the insertion of the gas filling nozzle in the first opening.

The guiding means may be adapted to cooperate with locking means associated with the gas filling nozzle for locking the gas filling nozzle to the housing once inserted.

The gas filling nozzle and the first opening may be sealed from the exterior by means of an o-ring.

The gas filling nozzle may force the disc away from the second opening when the gas filling nozzle is locked in the first opening.

The inflation valve may be, adapted to enable measuring of air pressure inside the container.

The resilient member may be a spring.

The housing may be provided with a pin for deflating the container.

The resilient member made be shaped as to cover the disc.

The invention also extends to a container with non-rigid walls provided with an inflation valve as set out herein.

The container may beta dunnage bag, a sack and/or any other flexible container to be pressurized.

The housing and the filling nozzle may include cooperating threads.

The gas filling nozzle may be provided with an external thread and the first opening of the housing with an associated internal thread.

The housing may be made of plastics and may be injection moulded.

The disc and/or the tubular part may be made of plastics, such as polycarbonate or silicon, and may be injection moulded.

The resilient member may be made of suitable plastics material, such as silicon or rubber or other elastic material, and may be injection moulded.

The disc and the resilient member may be manufactured by means of a two-step injection moulding process.

The resilient member and the disc may be integrally formed.

The resilient member and the disc may both be made of silicon.

### BRIEF DESCRIPTION OF DRAWINGS

The invention will now be described by way of example with reference to the accompanying schematic drawings.

In the drawings there is shown in:

FIG. 1: a top view of an inflation valve in accordance with a first embodiment of the invention; and

FIG. 2: a sectional side view of the inflation valve seen along arrows II-II in FIG. 1.

FIG. 3: a top view of an inflation valve in accordance with a second embodiment of the invention; and

FIG. 4: a sectional side: view of the inflation valve seen along arrows II-IV in FIG. 3.

### DETAILED DESCRIPTION OF DRAWINGS

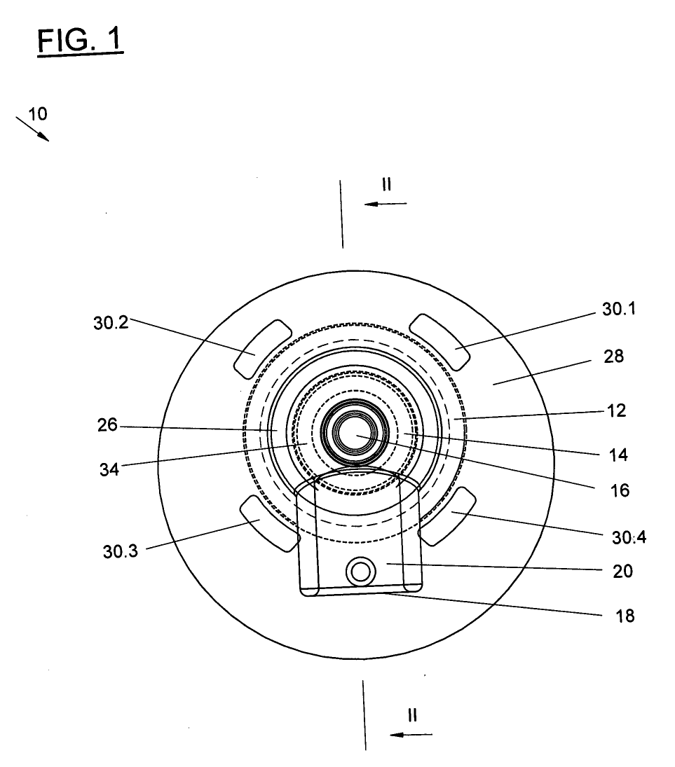

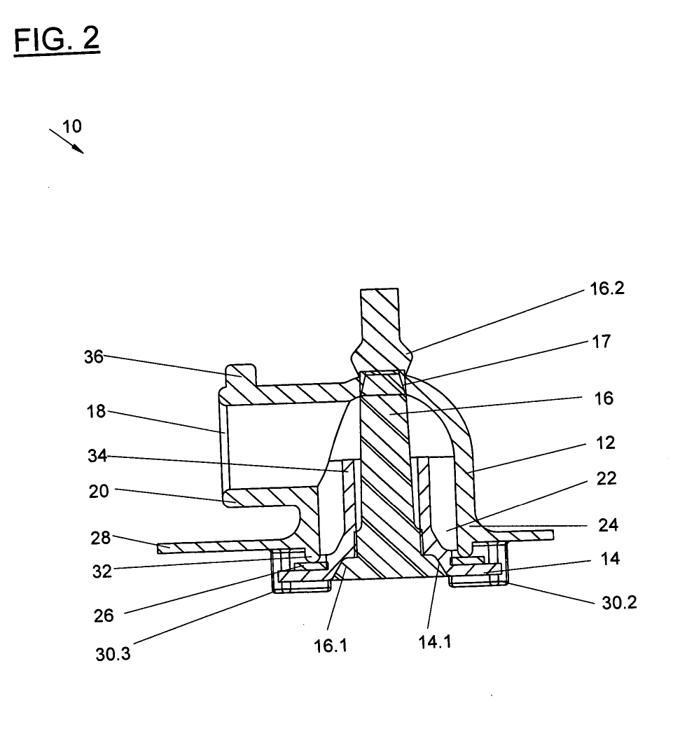

Referring to FIGS. 1 and 2, an inflation valve in accordance with a first embodiment of the invention, generally indicated by reference numeral 10; is shown.

The inflation valve 10 includes a housing 12, a disc 14 and a resilient member in the form of a rod 16 slidingly mounted in a passage 17 in the housing 12. The rod 16 may also be in the form of a spring-like member, such as a coil spring.

The housing 12 includes a first opening 18 at a first end 20 and a second opening 22 at a second end 24, the housing 12 being adapted to be secured to a container at the second end 24, and adapted to receive a gas filling nozzle (not shown) at the first end 20. The first opening 18 and the second opening 22 are perpendicular to each other. The housing 14 is generally made of plastics and by means of injection moulding.

The disc 14 is adapted to close-off the second opening 22 and is held in its closing position by means of the resilient member or rod 16. For this purpose the rod 16 has a widened part or collar 16.1 fitting into a recess 14.1 of the disc. The resilient member or rod 16 furthermore has a thickened part or knob 16.2 at its opposite end to prevent it from being pulled through the passage 17. The disc 14 is adapted to move away from the second opening 22 if gas is released by the filling nozzle, (not shown) into the housing 12. The disc 14 is provided with a washer 26. In a further is embodiment (not shown), the resilient member 16 is shaped as to cover the disc 14.

The housing 12 may be provided with a plate shaped part 28 for securing the valve 10 to the container. The plate shaped art 28 can be formed so as to be pivotally connected to the housing 12. The housing 12 is provided with guiding members 30.1, 30.2, 30.3, and 30.4 at the second end 24 to guide the disc 14. The housing 12 is also provided with a circumferential ridge 32 around the second opening 22 and against which the disc 14 abuts.

The disc 12 is provided with a tubular part 34 to receive the resilient member 16. The tubular part 34 is adapted to protect the resilient member 16 from the gas filling nozzle and to enable the gas filling nozzle to push the disc 12 down during inflation so that the pressure inside the container can be determined. The disc 14 and the tubular part 34 is made of plastics, such as polycarbonate, and are injection moulded the resilient member 16, is made of suitable plastics material, such as silicon or rubber or other elastic material, and is also injection moulded. The disc 14 and the resilient member, 16 are conveniently manufactured by means of a two-step injection moulding process. In an alternative embodiment the disc 14 and the resilient member 16 are integrally formed from silicon.

The housing 12 is provided with guiding means 36 for guiding the insertion of the gas filling nozzle in the first opening 18. The guiding means 36 may be adapted to cooperate with locking means (not shown) associated with the gas filling nozzle once the gas filling nozzle: is inserted in the first opening 14.

The housing 12 can be provided with deflating means, e.g. a pin (not shown), for deflating the container when inflated.

The gas filling nozzle and the first opening 18 may be sealed from the exterior by means of an o-ring (not shown). In a further embodiment (not shown), the housing 12 and the filling nozzle include cooperating threads, e.g. the gas filling nozzle may be provided with an external thread and the first opening of the housing with an associated internal thread.

In use, the gas filling nozzle is inserted through the first opening 18 of the housing 12 and the gas filling nozzle is turned to enabling locking of the gas filling nozzle to the housing 12, the gas filling nozzle forces the tubular part 34 of the disc 14 towards the second opening 22 and thus the disc 14 away from the second opening 22, with the result that the second opening 22 is opened. This position enables measurement of the air pressure inside the container.

Once gas is released into the housing 12 via the gas filling nozzle, the gas pressure forces the disc 14 away from the second opening 22 against the action of the resilient member 16, with the result that the second opening 22 is opened and the gas enters the container. Once the gas filling nozzle is removed from the housing 12, the resilient member 16 pulls the disc 14 towards the second opening 22, and thus causing sealing and closing-off of the second opening 22.

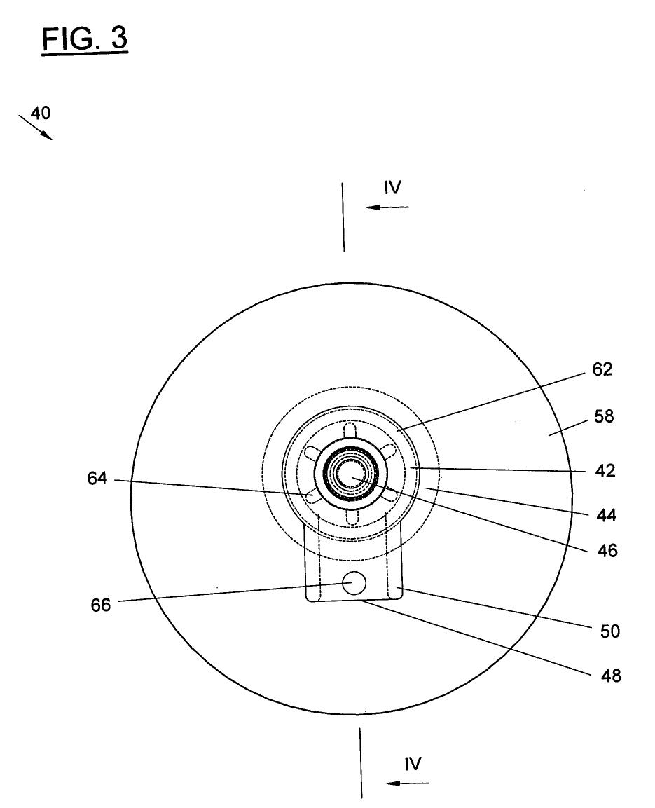

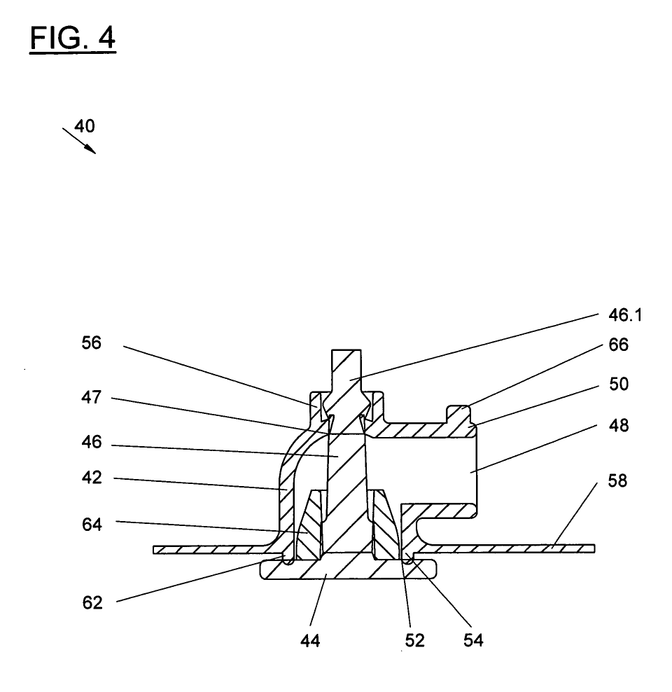

Referring to FIGS. 3 and 4, an inflation valve in accordance with a second embodiment of the invention, generally indicated by reference numeral 40, is shown.

The inflation valve 40 includes a housing 42, a disc 44 and a resilient member in the form of a rod 46: slidingly mounted in a pas sage 47, in the housing 42. The rod 46 may also be in the form of a spring-like member, such as a coil spring.

The housing 42 includes a first opening 48 at a first end 50 and a second opening 52 at a second end 54, the housing 42 being adapted to be secured to a container at the second end 54, and adapted to receive a gas filling nozzle (not shown) at the first end 50. The first opening 48 and the second opening 52 are perpendicular to each other. The housing 44 is generally made of plastics and by means of injection moulding.

The disc 44 is adapted to close-off the second opening 52 and is held in its closing position by means of the resilient member or rod 46. For this, purpose the rod 46 is integrally formed with the disc 44. The resilient member or rod 46 furthermore has a thickened part or knob 46.1 at its opposite end to prevent it from being pulled through the passage 47. A collar 56 is provided around the passage 47 in the housing 42 in order to protect the knob 46.1. The disc 44 is adapted to move away from the second opening 52 if gas is released by the filing nozzle (not shown) into the housing 42.

The housing 42 may be provided with a plate shaped part 58 for securing the valve 40 to the container. The plate shaped part 58 can be formed so as to be pivotally connected to the housing 42. The housing 42 is also provided with a circumferential ridge 62 around the second opening 52 and against which the disc 44 abuts.

The disc 42 is provided with a tubular part 64 to receiver the resilient member 46. The tubular part 64 is adapted to protect the resilient member 46 from the gas filling nozzle and to enable the gas filling nozzle to push the disc 42 down during inflation 80 that the pressure inside the container can be determined. The tubular part 64 is made of plastics; such as polycarbonate, and are injection moulded. The disc 44 and the resilient member 46 are made of suitable plastics material, such as silicon or rubber or other elastic material, and are also injection moulded. The disc 44 and the resilient member 46 are conveniently manufactured by means of a two-step injection moulding process. Thus, the disc 44 and the resilient member 46 are integrally formed from silicon.

The housing 42 is provided with guiding means 66 for guiding the insertion of the gas filling nozzle in the first opening 48. The guiding means 66 may be adapted to cooperate with locking means (not shown) associated with the gas filling nozzle once the gas filling nozzle is inserted in the first opening 44.

The housing 42 can be provided with deflating means, e.g. a: pin (not shown), for deflating the container when inflated.

The gas filling nozzle and the first opening 48 may be sealed from the exterior by means of an o-ring (not shown). In a further embodiment (not shown), the housing 42 and the filling nozzle include cooperating threads, e.g. the gas filling nozzle may be provided with an external thread and the first opening of the housing with an associated internal thread.

In use, the gas filling nozzle is inserted through the first opening 48 of the housing 42 and the gas filling nozzle is turned to enabling locking of the gas filling nozzle to the housing 42, the gas filling nozzle forces the tubular part 64 of the disc 44 towards the second opening 52 and thus the disc 44 away from the second opening 52, with the result that the second opening 52 is opened. This position enables measurement of the air pressure inside the container.

Once gas is released into the housing 42 via the gas filling nozzle, the gas pressure forces the disc 44 away from the second opening 52 against the action of the resilient member 46, with the result that the second opening 52 is opened and the gas enters the container. Once the gas filling nozzle is removed from the housing 42, the resilient member 46 pull the disc 44 towards the second opening 52, and thus causing sealing and closing-off of the second opening 52.

Thus the inflation valve, in accordance with the invention, provides a novel valve for containers with non-rigid walls such as dunnage bags, sacks and/or any other flexible containers to be pressurized.

### LIST OF REFERENCE NUMERALS

10 inflation valve
12 body
14 disc
14.1 recess
16 resilient member
16.1 collar
16.2 knob
17 passage
18 first opening
20 first end
22 second opening
24 second end
26 washer
28 plate shaped part
30.1 guiding member
30.2 guiding member
30.3 guiding member
30.4 guiding member
32 circumferential ridge
34 tubular part
36 guiding means
40 inflation valve
42 body
44 disc
46 resilient member
46.1 knob
47 passage
48 first opening
50 first end
52 second opening
54 second end
56 collar
58 plate shaped part
62 circumferential ridge
64 tubular part
66 guiding means

1. An inflation valve for inflating containers, which includes
(a) a housing including a first opening at a first end and a second opening at a second end, the housing being adapted to be secured to a container at the second end, and adapted to receive a gas filling nozzle at the first end;
(b) a disc adapted to close-off the second opening; and
(c) a resilient member associated with the housing and the disc, and being adapted in its inoperative position to hold the disc against the second opening to close it off, and when gas is released by a gas filling nozzle into the housing to allow the disc to move away from the second opening against the action of the resilient member.

2. An inflation valve as claimed in claim 1, which is adapted; to be connected to a container including non-rigid walls.

3. An inflation valve as claimed in claim 1, in which the first opening and the second opening are arranged to be substantially perpendicular to each other.

4. An inflation valve as claimed in claim 1, in which the housing is provided with a plate shaped part for securing the valve to the container.

5. An inflation valve as claimed in claim 4, in which the plate shaped part is pivotally connected to the housing.

6. An inflation valve as claimed in claim 1, in which the housing is provided with guiding members at the second end to guide the disc between the operative position and inoperative position and vice versa.

7. An inflation valve as claimed in claim 1 in which at least one washer is provided adjacent the disc and about the second spring for allowing the disc to abut against it.

8. An inflation valve as claimed in claim 1, in which the housing is provided with a circumferential ridge around the second opening and against which the disc abuts for closing off the second opening.

9. An inflation valve as claimed in claim 1, in which the disc is provided with a tubular part to receive the resilient member.

10. An inflation valve as claimed in claim 9, in which the tubular part is adapted to protect the resilient member from a gas filling nozzle when fitted to the first end of the housing.

11. An inflation valve as claimed in claim 1, in which the resilient member is an elongated rod slidingly arranged in a passage in the housing and having knobs at either end for preventing the rod from being withdrawn from the passage.

12. An inflation valve as claimed in claim 1, in which the housing is provided with guiding means for guiding the insertion of a gas filling nozzle into the first opening.

13. An inflation valve as claimed in claim 12, in which the guiding means are adapted to cooperate with locking means associated with a gas filling nozzle for locking such a gas filling nozzle to the housing once inserted into the first end of the housing.

14. An inflation valve as claimed in claim 1, in which an O-ring is provided for sealing a gas filling nozzle, when fitted to the first end of the housing, and the first opening from the exterior.

15. An inflation valve as claimed in claim 1, in which the disc is adapted to be forced away from the second opening by a gas filling nozzle when such a gas filling nozzle is locked in the first opening.

16. An inflation valve as claimed in claim 1, which is adapted to enable measuring air pressure inside a container.

17. An inflation valve as claimed in claim 1, in which, the resilient member a spring-like member, such as a coil spring.

18. An inflation valve as claimed in claim 1, in which the housing is provided with deflating means for deflating a container when inflated.

19. An inflation valve as claimed in claim 1, in which the resilient member is shaped to cover the disc substantially fully.

20. An inflation valve as claimed in claim 1 which is adapted to cooperate with a container in the form of a dunnage bag, a sack and/or any other flexible container to be pressurized.

21. An inflation valve as claimed in claim 1, in which the housing has a thread to cooperate with corresponding threads in a gas filling nozzle.

22. An inflation valve as claimed in claim 1, in which the first opening of the housing is provided with an internal thread associated with an external thread provided on a gas filling nozzle.

23. An inflation valve as claimed in claim 1, in which the housing is made of plastics and is injection moulded.

24. An inflation valve as claimed in claim 1, in which the disc and/or the tubular part is made of plastics such as polycarbonate or silicon, and is injection moulded.

25. An inflation valve as claimed in claim 1, in which the resilient member is made of suitable plastics material, such as silicon or rubber or other elastic material, and is injection moulded.

26. An inflation valve as claimed in claim 1, in which the disc and the resilient member are manufactured by means of a two-step injection moulding process.

27. An inflation valve as claimed in claim 1, in which the resilient member and the disc are integrally formed.

28. An inflation valve as claimed in claim 1, in which the resilient member and the disc are both made of silicon.

29. An inflatable container, which includes an inflation valve as claimed in claim 1.

30. An inflatable container as claimed in claim 29, which is a container selected from the group comprising a dunnage bag, a sack and a flexible container to be pressurized.
